(19) United States
(12) Patent Application Publication
(10) Pub. No.: US 2018/0127193 A1
(43) Pub. Date: May 10, 2018

(54) RECEPTACLE FOR CONTAINING AND DISPENSING SOLID MEDICINAL PILLS

(71) Applicant: P.C.O.A. DEVICES LTD., Tel Aviv (IL)

(72) Inventor: Ilan Paz, Alon Shvut (IL)

(21) Appl. No.: 15/687,244

(22) Filed: Aug. 25, 2017

Related U.S. Application Data
(63) Continuation of application No. 14/418,149, filed on Jan. 29, 2015, now abandoned.

(30) Foreign Application Priority Data
Jul. 30, 2012 (IL) 221186
Apr. 30, 2013 (IL) 226074

(51) Int. Cl. B65D 83/04; A61J 7/00; A61J 1/03

(52) U.S. Cl. CPC B65D 83/04; B65D 83/0463; B65D 83/0409; A61J 1/03; A61J 7/0053; A61J 1/035; A61J 7/0076

(57) ABSTRACT

A receptacle (100) for containing and dispensing a solid medicinal pill (108), directly into the mouth of the user, comprising a container with a storage chamber (104) leading to a spout outlet (106) sized to be comfortably inserted between the lips of a user, said spout outlet being further provided with a displaceable sealing closure (112) having a normally closed position, and wherein displacement of said closure from said closed position, to enable the dispensing of at least one pill from said chamber, is actuated by the mouth of the user interacting with said spout outlet.

### FIELD OF THE INVENTION

The present invention relates to the field of controlled medication administration. Particularly, the present invention relates to medication dispensers. More particularly, the present invention relates to a receptacle for containing and dispensing solid medicinal pills.

### BACKGROUND OF THE INVENTION

A major problem in hospitals and nursing facilities, where pills are dispensed on a regular basis, is that pills are brought manually by a medical person to a patient who then manually takes them for swallowing. Unfortunately, many patients receiving medication are groggy, shaky or infirm. During the handling of the pills, the patient may drop the pills, which will result in their becoming contaminated or even lost.

Another serious problem in hospitals, and in general, is with the control of the distribution of narcotic pain killers, where patients are known to palm the same in order to transfer and/or sell the pill to an unauthorized user.

It is an object of the present invention to obviate these and other associated problems by providing a receptacle for containing and dispensing solid medicinal pilis wherein said receptacle is provided with dispensing means provided with a sealable dispensing closure, wherein displacement of the closure from its sealed position, to enable the dispensing of a pill, is actuated by the mouth of the user.

Since the unique receptacle of the present invention is designed to specifically and only dispense one or more pills directly into the mouth of the designated patient there is no danger that a patient who is groggy, shaky or infirm will drop the pill(s) and much less danger of transfer and/or sale of a pill to an unauthorized user once it has been in the mouth of the designated patient.

There exist prior art devices for containing and dispensing solid medicinal pills, however, they all have difficulties or drawbacks associated with them.

U.S. Pat. No. 5,259,531 to Bennett discloses a container for storing and dispensing pills which dispenses individual pills by manually operating a lever. The container employs a hollow vertical cylinder having an upper region for receiving pills and a lower region from which pills are dispensed. The lower region has a first opening in its lower end which is adapted to pass a pill therethrough and has at least one second opening in its side wall. In use, it is first necessary to fill the upper region with pills to be dispensed. The container is then tapped gently or subjected to similar movements, and one of the pills in the upper region will be moved into engagement with a section which is connected to a lever. When the lever is in its first position, the section is placed under the third opening in order to receive any pill delivered through the third opening thereto. When the lever is in its second position, the section is placed above the first opening in order to deliver any pill previously received by the section to the first opening for discharge therethrough.

Bennett's container is manually operable which requires the user to remove the pill therefrom and transfer it to his mouth via his hand. Thus, a groggy, shaky or infirm user may drop, contaminate and even lose the pill, as described herein above.

U.S. Pat. No. 4,402,425 to von Schukmann discloses a tablet dispensing container having a spring-loaded slide pushbutton operated to release one tablet and bottom projection to hold back others. The container for the dispensing of individual tablets one by one comprises a tablet drop-out opening provided in the wall of the container below a storage chamber, a spring-loaded slide traveling in front of the region of the opening and releasing in each case one of the tablets so that it can drop out, the slide having associated with it a division finger which, in the depressed position of the slide which is continued towards the outside by an actuating button, blocks the path between the bottom opening of the storage chamber and the tablet drop-out opening.

Similar to the drawback associated with Bennet's container, the container of von Schukmann is not intended for the user to distribute the pills directly into his mouth, rather into his hand, thereby potentially resulting in contamination or loss of the pill prior to ingestion.

Additional prior art documents that describe devices for dispensing solid medicaments such as pills, tablets and the like include: U.S. Pat. No. 5,657,901, FR 2,637,266, US 2007/114239, U.S. Pat. No. 4,354,619, US 2004/124204, U.S. Pat. No. 7,147,130, U.S. Pat. No. 5,850,919, U.S. Pat. No. 5,018,644, U.S. Pat. No. 4,653,668, U.S. Pat. No. 4,744,492, U.S. Pat. No. 4,784,291 and U.S. Pat. No. 6,131,765. However, none the above patent documents solve the problems associated with pill dispensers as described herein above.

JP 2008110158 to Ilzuka discloses an inhalation-type medicine delivery device that has a body having a storage chamber storing the capsule filled with a medicine, a piercing means to make a hole in the capsule arranged in the storage chamber of the body, and a mouthpiece to inhale the medicine of the pierced capsule through a discharge route connected with the storage chamber. The body is composed of a cylindrical member having openings in two positions. The mouthpiece is provided in one opening Id of the cylindrical member and a lid member openably connected with the cylindrical member through a connecting portion such as a pivot or a hinge and opening the inlet of the storage chamber to load the capsule in an open state is provided in the other opening le of the cylindrical member. A check valve permitting outside air to be conducted into the body only during aspiration by the mouthpiece is arranged in the lid member.

Ilzuka's device allows the user to avoid manual handling of the pill, however it is a complex design, which adds to the cost of manufacturing as well as the sale price. Furthermore said device is, like many inhalators, designed to deliver a fine powder from the capsule and not the capsule itself.

Accordingly, it is a principal object of the present invention to provide a receptacle for containing and dispensing solid medicinal pills, that overcomes the difficulties and drawbacks associated with the prior art as described in part herein above.

Additionally, it is an object of the present invention to provide a receptacle for containing and dispensing solid medicinal pills in hospitals and nursing facilities as well as at home.

It is yet another object of the present invention to provide a receptacle for containing and dispensing solid medicinal pills, one or more at a time, whenever used in conjunction with an automated medication dispenser of the type enabling the controlled sequential delivery of a regimen of pills on an as-needed basis.

It is another object of the present invention to provide a receptacle for containing and dispensing solid medicinal pills that prevents contamination or loss of the drug prior to reaching the patient.

It is yet another object of the present invention to provide a receptacle for containing and dispensing solid medicinal pills that is easy and inexpensive to manufacture, and simple to use.

Additional objects and advantages of the invention will become apparent as the description proceeds.

### SUMMARY OF THE INVENTION

In accordance with a preferred embodiment of the present invention, a receptacle for containing and dispensing solid medicinal pills directly into the mouth of the user, is disclosed, comprising a container with a storage chamber leading to a spout outlet sized to be comfortably inserted between the lips of a user. The spout outlet is further provided with a displaceable sealing closure having a normally closed position, wherein displacement of the closure from the closed position, to enable the dispensing of at least one pill from the chamber, is actuated by the mouth of the user interacting with the spout outlet.

The displacement of the closure from the closed position, to enable the dispensing of at least one pill from the chamber, is preferably actuated by an air pressure differential, particularly by suction, inhalation or exhalation applied to the spout and the closure by the mouth of the user.

Preferably, the inner cross-section of the opening of the spout is less than 4, optionally less than 3 cm.

The receptacle preferably additionally comprises an inlet for introducing at least one solid medicinal pill into the chamber to be dispensed via the spout outlet.

According to one aspect, the inlet is hingedly attached to an opening provided in a surface of the container. According to another aspect, the inlet comprises a one-way valve. According to another embodiment inlet comprises an opening covered by a semi-flexible material having a resealably openable slit.

Preferably, the receptacle is provided with a handle for bringing and positioning the spout outlet of the receptacle in dispensing relation vis-a-vis the mouth of the user.

The sealing closure is preferably maintained in its closed position by interengagement with a frame provided inside the spout outlet. Preferably, the sealing closure is hingedly attached to an at least partially flexible frame means provided inside the spout and the portal is held maintained in its closed position by interengagement with the flexible frame.

The at least partially flexible frame is preferably provided with an opening sealable by the sealing closure and the portal is displaceable through the opening in response to an air pressure differential between the two sides of the frame.

The at least partially flexible frame is preferably provided with an opening sealable by the sealing closure and the closure is inwardly displaceable through the opening toward the chamber for insertion of pills therein and outwardly displaceable toward the spout outlet for dispensing of pills to the mouth of the user.

In especially preferred embodiments of the present invention, the receptacle is used for dispensing at least one pill from said chamber, wherein any one linear measurement of the pill is between 3 mm and 30 mm.

The receptacle is preferably used in conjunction with an automated, controlled, solid pill medication dispenser.

The dispensing receptacle is preferably provided in conjunction with an integral housing, which integral housing is lockable to a pill dispenser, and the integral housing and dispensing receptacle are together disposable, to enable sequential use of the dispenser by multiple sequential patients with a new integral housing and dispensing receptacle attached to the dispenser for each sequential patient.

The disclosed receptacle for containing and dispensing solid medicinal pills, one or more at a time, is provided whenever used in conjunction with a medication dispenser of the type enabling the controlled sequential delivery of a regimen of pills on an as-needed basis with a predetermined prescribed minimum time interval between delivery of each type of pill, from any standard commercial flat multiple pill-containing pack of the blister package type having at least one column of pills to be dispensed, the dispenser comprising:

a. an access portal sized to receive at least one any such blister pack and to guide the pack to at least one motor driven blister-pack advancing unit which in turn sequentially advances the pack to a stationary depilling station, the station comprising:
i. pill detecting means;
ii. a blister pack support having at least one pill receiving aperture, sized and positioned to receive pills of different sizes, shapes and spacing in the blister pack array; and,
iii. motor driven depilling press means positioned, upon activation, to force one pill at a time from its respective blister through the backing of the blister via said aperture as the blister pack is advanced through the stationary depilling station within the dispenser;

b. a channel into which the pill enters from the aperture; and,

c. a dispensing receptacle according to the present invention for receiving the pill from the channel.

Optionally said displaceable sealing closure is formed from a plurality of flexible flaps. Optionally said flexible flaps are at least partially overlapping.

Alternatively said displaceable sealing closure is formed from a plurality of flexible filaments.

Optionally said spout outlet is releasably connected to said receptacle.

In other embodiments of the present invention said releasable spout outlet is disposable and replaceable.

Optionally said spout outlet is provided with a stop surface positioned in spaced apart relationship, relative to and outwardly in front of said displaceable sealing closure, said stop surface being provided with at least one air hole enabling air displacement between the mouth of the user and said closure, to open the same, said surface being adapted to deflect a pill exiting said closure and encountering said surface, said spout outlet being further provided with an opening, positioned to dispense, under the effect of gravity, a pill exiting said closure, irrespective of whether said pill reaches said stop surface and is deflected thereby or not.

While the opening of the displaceable sealing closure according to the present invention is preferably activated by the user blowing air into the receptacle to force open the sealing closure or applying suction generated by cheek or lung action to pull the closure open towards the user, it is possible to have other alternative mouth activated opening mechanisms such as a mechanical latch operated by the pressure of the lips, teeth or jaws of the user, a sensor of the temperature of the breath of the user when said breath is exhaled into the receptacle, a sensor activated by the humidity of the breath of the user when said breath is exhaled into the receptacle, or even a carbon dioxide sensor activated by the content of the expelled breath of the user.

To accomplish the above and related objects, the invention may be embodied in the form illustrated in the accompanying drawings. With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description taken with the attached figures making apparent to those skilled in the art how the several forms of the invention may be embodied in practice.

### BRIEF DESCRIPTION OF THE DRAWINGS

FIG. 1 shows the receptacle of the present invention, for containing and dispensing solid medicinal pills, in a cross-sectional side view, having a pill within the storage chamber;

FIGS. 2a and 2b show outlet closure pivoted outward toward the opening of the receptacle

(FIG. 2a), and the closure pivoted inward toward the storage chamber of the receptacle (FIG. 2b);

FIG. 3 shows an alternative embodiment of the receptacle, wherein the storage chamber comprises an inlet through which one or more pills are insertable and a handle for enabling the user to grasp the container to bring the receptacle close to the user's mouth and position the spout outlet within the mouth of the user;

FIG. 4 shows the embodiment of the receptacle of FIG. 3, further comprising a integral housing, which is lockable to an automated, controlled solid pill medication dispenser;

FIG. 5 is a front perspective view of a medication dispenser according to Israel Specification No: 220,794 with the receptacle of the present invention incorporated therein;

FIG. 6 shows a receptacle of the present invention, for containing and dispensing solid medicinal pills, in a cross-sectional side view, having a pill within the storage chamber wherein the displaceable sealing closure is formed from a plurality of flexible flaps which are at least partially overlapping as shown in FIG. 6a;

FIG. 6b shows a sealing closure formed from a plurality of flexible filaments;

FIG. 7 shows a receptacle of the present invention, for containing and dispensing solid medicinal pills, in a cross-sectional side view, having a pill within the storage chamber and

FIGS. 7a and 7b are partial views of the receptacle of FIG. 7 in which the spout outlet is respectively, releasably connected to and disconnected from said receptacle, said spout outlet being provided with a stop surface and with air holes enabling air displacement between the mouth of the user and the closure of the receptacle, said spout outlet being further provided with an opening, positioned to dispense, under the effect of gravity, a pill exiting said closure.

### DETAILED DESCRIPTION OF THE PREFERRED EMBODIMENTS

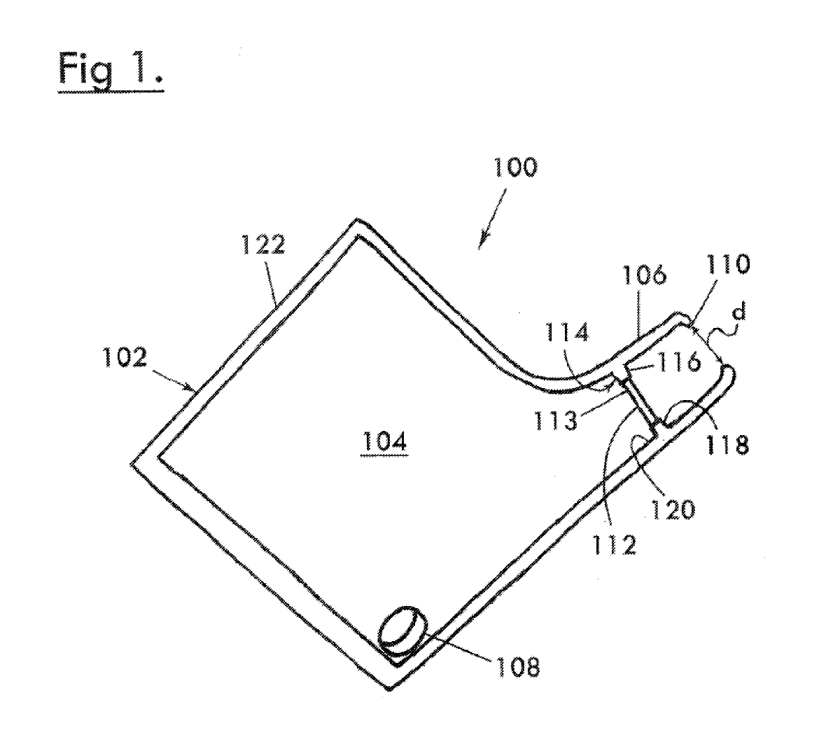

A preferred embodiment of the receptacle of the present invention, for containing and dispensing solid medicinal pills, is shown in a cross-sectional side view in FIG. 1, and generally designated by numeral (100). Receptacle (100) comprises a container (102) with a storage chamber (104) leading to a spout outlet (106). Pill (108) is shown positioned in storage chamber (104).

Spout outlet (106) is shaped and sized in a manner such that it is comfortable to dispose spout outlet (106) between the lips of a user (not shown). To that end the inner diameter (d) of the opening (110) of spout outlet (106) is less than 4, preferably less than 3 cm, which also assures ready passage of the pill (108) through opening (110) of spout outlet (106) and prevents easy manual removal of the pill from the chamber.

A preferred embodiment of a displaceable sealing closure (112) is shown in FIG. 1, having a normally dosed position. The displacement of closure (112) from the normally closed position to an open position that enables the dispensing of a pill from storage chamber (104) is preferably actuated by the mouth of the user when interacting with spout outlet (106), as described further herein below.

According to a preferred embodiment, closure (112) is maintained in its normally closed position by interengagement with a frame (114), provided inside spout outlet (106), and which surrounds closure (112). One end (113) of closure (112) is preferably hingedly attached to one end (116) of frame (114) for enabling closure (112) to selectively pivot inward toward storage chamber (104) and outward toward opening (110).

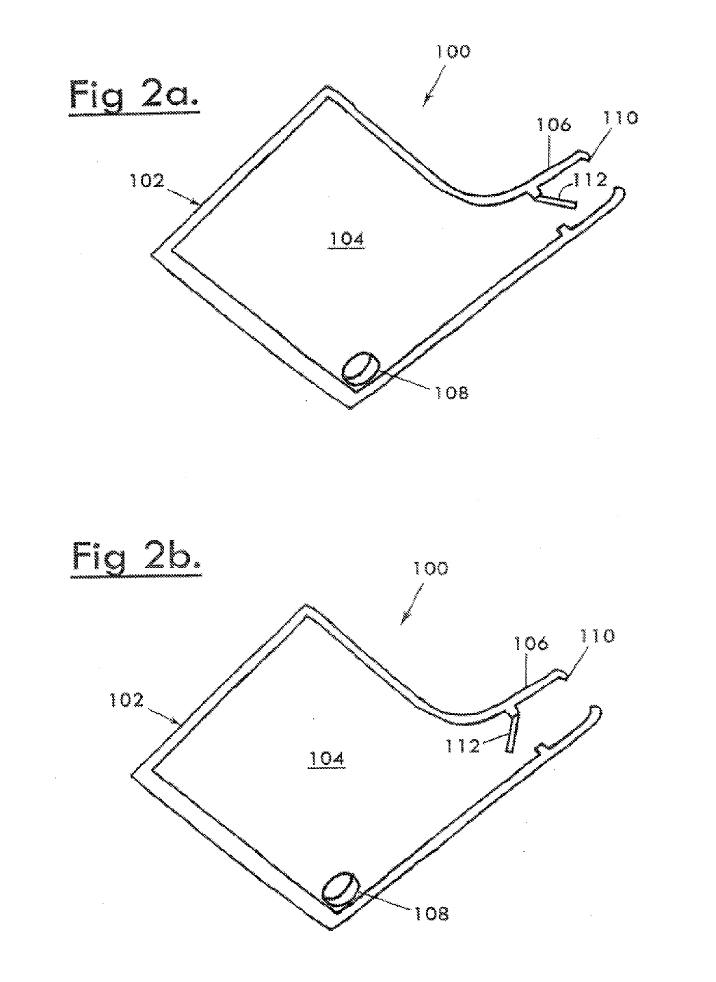

The displacement (i.e. pivoting) of closure (112) via the mouth of the user as mentioned above is actuated by an air pressure differential, wherein the differential may be produced by one or more of the suction, inhalation and exhalation created by the mouth of the user. When the user creates a suction or inhalation with his mouth closure (112) pivots outward toward opening (110) (see FIG. 2a), and when the user creates an exhalation with his mouth, closure (112) pivots inward toward storage chamber (104) (see FIG. 2b).

Additionally, the inward displacement of closure (112) may be actuated by a pusher device (not shown) which is inserted through opening (110) for providing a force on closure (112) similar to that provided by the exhale pressure created by the mouth of the user in order to initially insert one or more pills into chamber (104) for later mouth actuated dispensing. The pusher device may be a narrow elongated object that is held by a hand and thrust toward closure (112). The mouth of the user is typically used to actuate the displacement of closure (112) when the user desires to ingest a pill (108) contained in storage chamber (104). The pusher device is typically used to actuate the displacement of closure (112) when the user or medication distributor desires to insert a pill (108) into storage chamber (104).

With reference to FIG. 1, at least the end (118) of frame (114) opposite that of end (116) of frame (114) with which closure (112) is hingedly connected, is made of a flexible material, such as rubber or other sealing material, for providing a sealed relationship between frame (114) and closure (112). Preferably the entire inner periphery of frame (114) is made of a flexible, sealing material.

In an alternative embodiment (not shown) at least one end of closure (112) comprises a flexible, sealing material for providing a sealed relationship directly with the inner wall (120) of spout outlet (106).

When a pill (108) is disposed in storage chamber (104), following the inward or outward displacement of closure (112), pill (108) is discharged from receptacle (100) through opening (110) of spout outlet (106) directly into the user's mouth. Hence, the potential problems resulting from having an unsteady person handling the pill is avoided. Additionally, the chances of unauthorized transferring or selling of a narcotic pain killer after contamination via contact with the mouth of a user is greatly diminished.

Once the user discontinues the suction, inhalation or exhalation with his mouth, closure (112) pivots in an opposite direction and returns to the normally closed position. Similarly, when the pusher device is removed from spout outlet (106) after being used to inwardly displace closure (112), closure (112) pivots in an opposite direction and returns to the normally closed position.

According to a preferred embodiment of the present invention, the walls (122) of storage chamber (104) are sealed such that the only method of inserting a pill therein is through spout outlet (106).

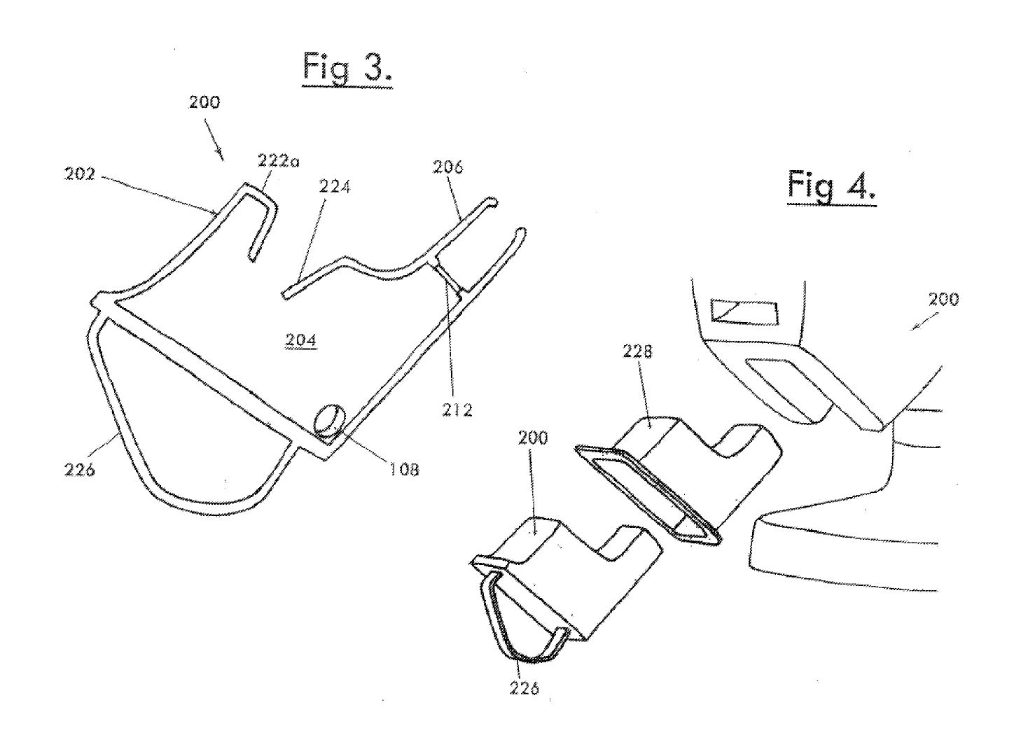

According to an alternative embodiment (200), as seen in FIG. 3, a wall (222a) of storage chamber (204) comprises a one-directional trap (224) through which one or more pills (108) are insertable. One-directional trap (224) enables pills to enter into storage chamber (204) while reducing the chances of the pills exiting therethrough. In an alternative aspect, the inlet comprises an opening (not shown) that is covered by, for instance, a semi-flexible material comprising a slit. Pills may enter into the storage chamber by the user providing a thrusting force for pushing the pills through the slit, but pills are unable to exit the storage chamber through the slit since a thrusting force large enough to pass the pills through the slit cannot be generated from within the storage chamber. In yet a further alternative aspect, the inlet comprises an opening (not shown) that is covered by a second closure, which is hingedly attached at one of its ends to an end of the opening.

According to one embodiment, as shown in FIG. 3, receptacle (200) additionally comprises a handle (226) for enabling the user to grasp container (202) thereby, and for bringing receptacle (200) close to the user's mouth and positioning spout outlet (206) within the mouth of a user, in a dispensing relationship. However, in alternative embodiments, receptacle (200) does not comprise a handle (not shown). Thus, when a user desires to receive a pill from receptacle (200) he manually positions receptacle (200) as desired by directly grasping the container (202).

In a preferred embodiment, receptacle (200) is used in conjunction with an automated, controlled solid pill medication dispenser, for instance, the medication dispenser described in Israeli patent application IL220794 by the same inventors as the present invention, the disclosure of which is fully incorporated by reference herein.

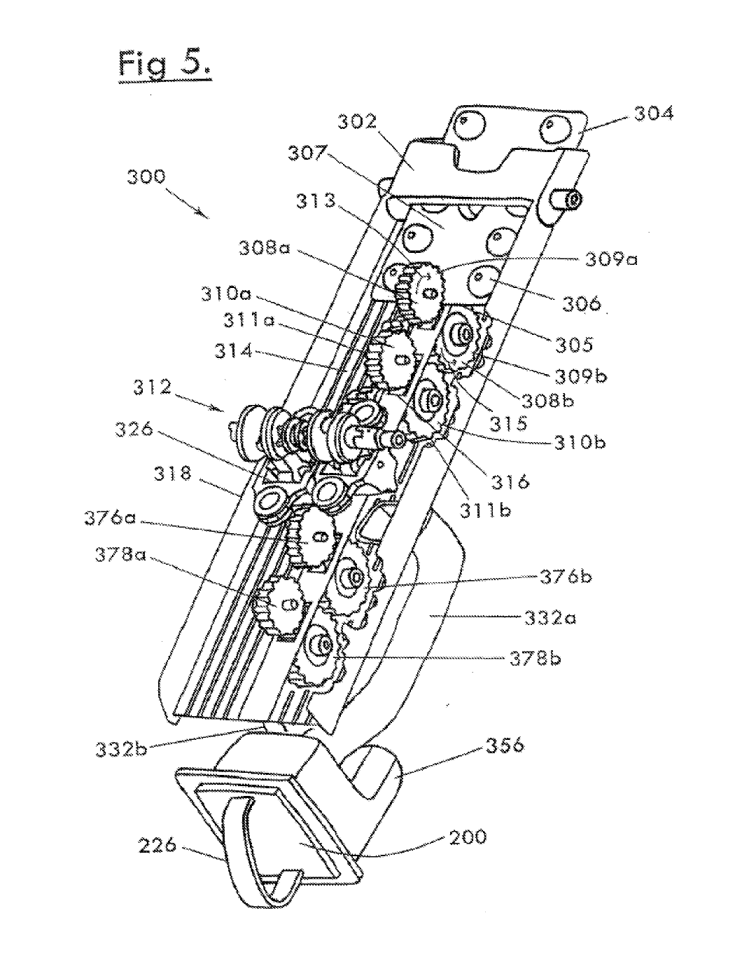

With reference to FIG. 4, receptacle (200) is further provided in conjunction with an integral housing (228), which is lockable to the pill dispenser (230) described in Israeli patent application IL220794. Both receptacle (200) and housing (228) are disposable in order to enable sequential use of pill dispenser (230) by multiple sequential patients, wherein a new receptacle (200) and housing (228) is provided to pill dispenser (230) for each sequential patient.

Thus, a preferred embodiment of the present invention further comprises a receptacle (200) for containing and dispensing solid medicinal pills, one or more at a time, when used in conjunction with a medication dispenser (230) of the type described in Israeli patent application IL220794, which enables the controlled sequential delivery of a regimen of pills on an as-needed basis with a predetermined prescribed minimum time interval between delivery of each type of pill, from any standard commercial flat multiple pill-containing pack of the double arrayed blister package type having two columns and a plurality of rows of pills to be dispensed.

The pill dispenser comprises an access portal sized to receive at least one of any such blister pack and to guide the blister pack to at least one pair of motor driven driving wheels which in turn sequentially advance the blister pack to a stationary depilling station. The depilling station comprises a pill detecting means; a blister pack support having two spaced-apart pill receiving apertures, each aperture being sized and positioned to receive pills of different sizes, shapes and spacing in the blister pack array; and, motor driven depilling press means positioned, upon activation, to force one pill at a time from its respective blister through the backing of the blister via one of the apertures, as the blister pack is advanced through the stationary depilling station within the dispenser.

The dispenser further comprises a channel into which the pill enters from the apertures, and a dispensing receptacle for receiving the pill from the channel.

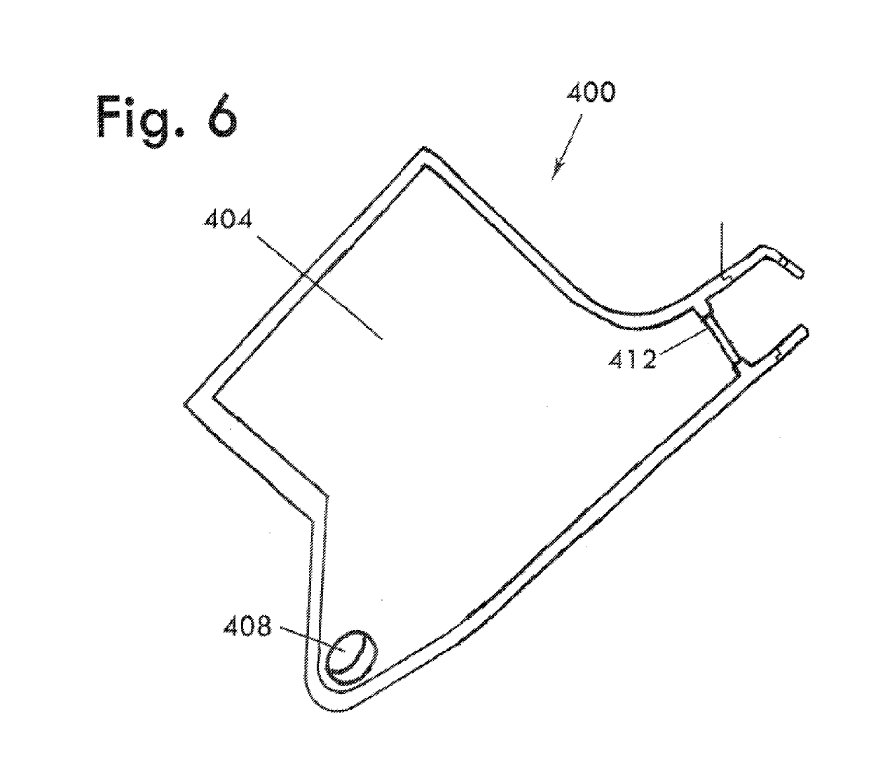

Referring now to FIG. 5; there is seen a front perspective view of a medication dispenser 300, wherein the outer housing is removed to show the inner components of the dispenser, which dispenser incorporates receptacle 200 of the present invention as seen in FIG. 3 therein. More specifically, there is seen dispenser (300) which comprises an access portal (302) through which a blister pack (304) is inserted. Blister pack (304) is preferably a standard commercial flat multiple pill-containing pack of the double arrayed blister package type, having two columns and a plurality of rows of pills (306). An authorized medical person manually inserts blister pack (304) through access portal (302) until distal edge (305) of blister pack (304) is received by a pair of motor driven driving wheels (308a), (308b), which are preferably spur gears.

In a preferred embodiment, a second pair of driving wheels (310a), (310b) is present, for advancing blister pack (304) toward the depilling station (312).

Still referring to FIG. 5, driving wheels (308a), (308b) and (310a), (310b) are positioned lengthwise along the central longitudinal axis of a blister pack support means, preferably comprising a surface (314) along which blister pack (304) is conveyed. Upper wheels (308a), (310a) are situated above surface (314) and lower wheels (308b), (310b) are situated below surface (314). Surface (314) is shown in FIG. 5 partially cut out in order to view lower wheels (308b), (310b). Longitudinally spaced openings (316) in surface (314) enable gear teeth (309a), (309b) and (311a), (311b) to mesh.

Referring to FIG. 3 in combination with FIG. 4, depilling station (112) and channels (132a), (132b) are shown in FIG. 3, and surface (114), blister pack (104), channels (132a), (132b) and one depilling means (126) are shown in FIG. 4, wherein the other components of the dispenser are removed for clarity.

As blister pack (304) reaches depilling station (312) a pill detecting means (not shown), comprising a sensor system having, for instance, an IR, a laser source and a detector, or any other detection system situated on opposing longitudinal sides of blister pack (304) to determine whether at least one pill is present in the first row of pills. If at least one pill is present, at least one depilling press means (326) of depilling station (312) is activated, for forcing one pill at a time from its blister out of the flat backing of blister pack (304), through pill receiving apertures (not shown) of surface (314).

In operation, once it is determined that, for instance, a depilling means (326) is positioned above a blister containing a pill (306), the depilling motor is actuated and depilling means (326) is lowered, thereby pushing pill (306) out of its blister through pill receiving aperture (not shown) into channel (332a), which channel opens into a pill dispensing receptacle (200) of the present invention via a one-way valve (not shown) that allows only one pill at a time to pass therethrough. As seen in FIGS. 3 and 4, the receptacle 200 is preferably provided with a handle (226) for enabling the user to manipulate the receptacle therewith.

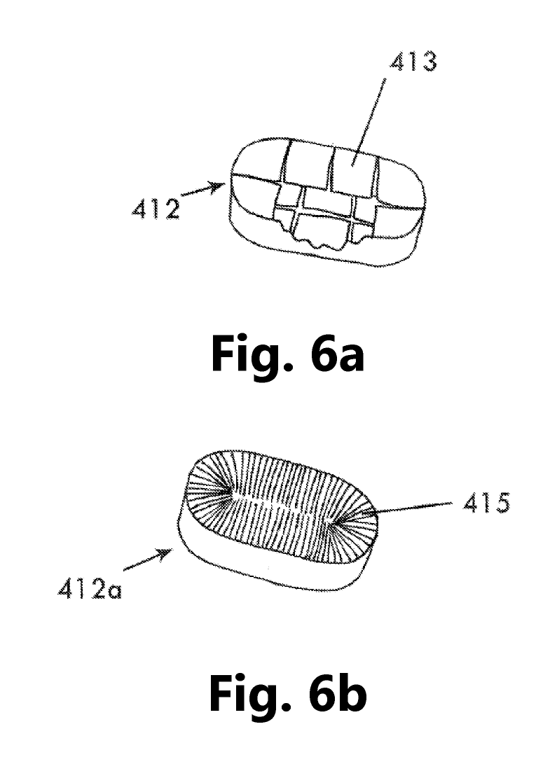

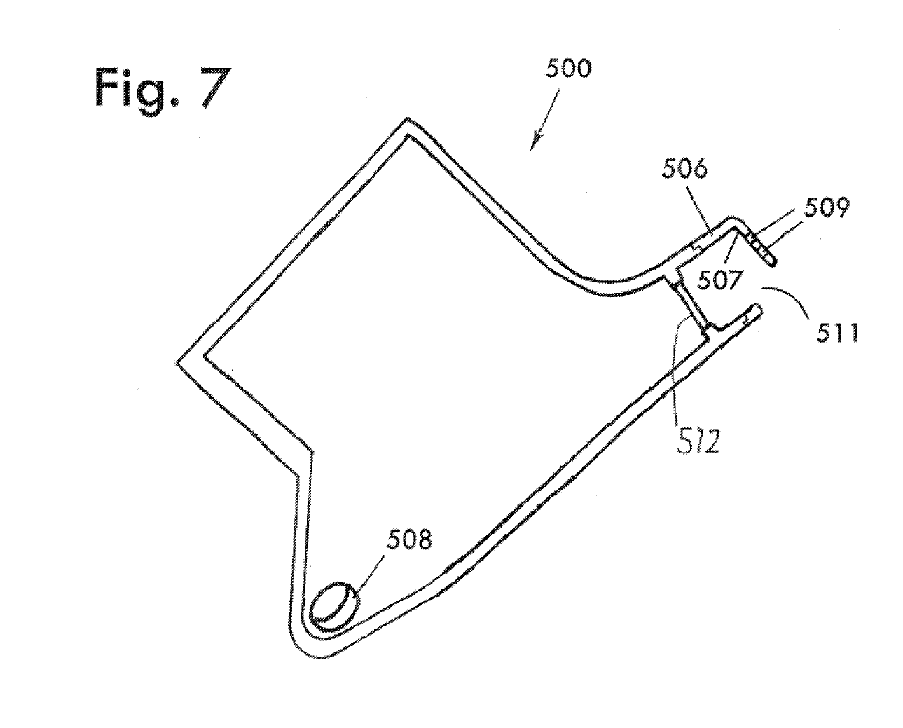

Referring to FIGS. 6 and 6a there is shown a receptacle (400) of the present invention, for containing and dispensing solid medicinal pills, (408) from a storage chamber (404), wherein the displaceable sealing closure (412) shown in FIG. 6a is formed from a plurality of flexible flaps (413) which are at least partially overlapping;

Referring to FIG. 6b there is shown an alternative embodiment in which the sealing closure (412) is formed from a plurality of flexible filaments (415).

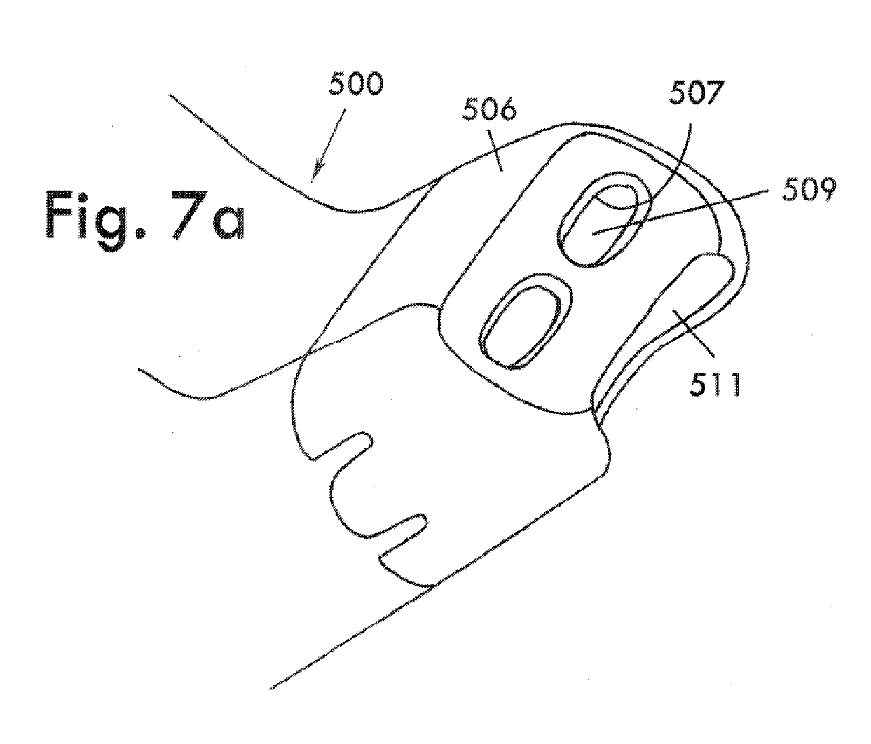

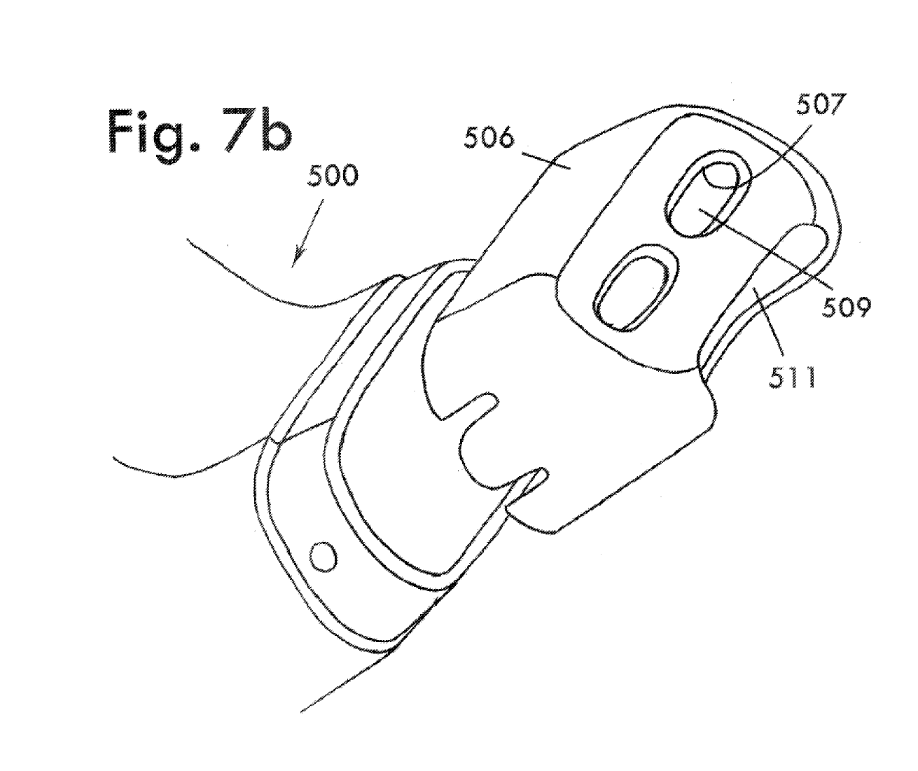

Referring now to FIGS. 7, 7a and 7b there are seen a cross-sectional view and two partial views, respectively, of a receptacle (500) of the present invention in which the spout outlet (506) is respectively, releasably connected to (as seen in FIG. 7a, and disconnected from, said receptacle (500) (as shown in FIG. 7b), In this embodiment said spout outlet (506) is provided with a stop surface (507) positioned in spaced apart relationship, relative to, and outwardly in front of, said displaceable sealing closure (512), said stop surface being provided with air holes (509) enabling air displacement between the mouth of the user and said closure, (512), to open the same, said surface (507) being adapted to deflect a pill (508) exiting said closure and encountering said surface (507), said spout outlet (506), being further provided with an opening (511), positioned to dispense, under the effect of gravity, a pill (508) exiting said closure, irrespective of whether said pill reaches said stop surface (507) and is deflected thereby or not.

It is understood that the above description of the embodiments of the present invention are for illustrative purposes only, and is not meant to be exhaustive or to limit the invention to the precise form or forms disclosed, as many modifications and variations are possible. Such modifications and variations are intended to be included within the scope of the present invention as defined by the accompanying claims.

1. A receptacle for containing and dispensing solid medicinal pills, directly into the mouth of the user, comprising a container with a storage chamber leading to an outlet sized to be comfortably inserted between the lips of a user, said outlet being further provided with a displaceable sealing closure having a normally closed position, wherein actuation by the mouth of the user interacting with said outlet causes displacement of said displaceable sealing closure from said closed position, to enable the dispensing of at least one pill from said chamber.

2. A receptacle for containing and dispensing solid medicinal pills according to claim 1, wherein displacement of said closure from said closed position, to enable the dispensing of at least one pill from said chamber, is actuated by suction applied to said outlet and said closure by the mouth of the user.

3. A receptacle for containing and dispensing solid medicinal pills according to claim 1, wherein displacement of said closure from said closed position, to enable the dispensing of at least one pill from said chamber, is actuated by suction applied to said spout and said closure by the mouth of the user or is actuated by exhalation applied to said outlet and said closure by the mouth of the user.

4. A receptacle for containing and dispensing solid medicinal pills according to claim 1, wherein the inner cross-section of the opening of said outlet is less than 4 cm.

5. A receptacle for containing and dispensing solid medicinal pills according to claim 1, additionally comprising an inlet for introducing at least one solid medicinal pill into said chamber to be dispensed via said outlet.

6. A receptacle for containing and dispensing solid medicinal pills according to claim 5, wherein said inlet is hingedly attached to an opening provided in a surface of said container, or wherein said inlet comprises an opening covered by a semi-flexible material having a resealably openable slit, or wherein said inlet comprises a one-way valve.

7. A receptacle for containing and dispensing solid medicinal pills according to claim 5, configured for use with an automated, controlled, solid pill medication dispenser.

8. A receptacle for containing and dispensing solid medicinal pills according to claim 1, wherein said receptacle is provided with a handle for bringing and positioning the outlet of the receptacle in dispensing relation vis-a-vis the mouth of the user.

9. A receptacle for containing and dispensing solid medicinal pills according to claim 1, wherein said sealing closure is hingedly attached to an at least partially flexible frame means provided inside said outlet and said sealing closure is maintained in its closed position by interengagement with said flexible frame.

10. A receptacle for containing and dispensing solid medicinal pills according to claim 9, wherein said at least partially flexible frame is provided with an opening sealable by said sealing closure, said sealing closure is displaceable through said opening in response to an air pressure differential between the two sides of said frame.

11. A receptacle for containing and dispensing solid medicinal pills according to claim 9, wherein said sealing closure is inwardly displaceable through said opening toward said chamber for insertion of pills therein and outwardly displaceable toward said outlet for dispensing of pills to the mouth of the user.

12. A receptacle for containing and dispensing solid medicinal pills according to claim 1, whenever used for dispensing at least one pill from said chamber any one linear measurement of said at least one pill being between 3 mm and 30 mm.

13. A receptacle for containing and dispensing solid medicinal pills according to claim 1, wherein said displaceable sealing closure is formed from a plurality of flexible flaps, or wherein said displaceable sealing closure is formed from a plurality of flexible filaments.

14. A receptacle for containing and dispensing solid medicinal pills according to claim 13, wherein said flexible flaps are at least partially overlapping.

15. A receptacle for containing and dispensing solid medicinal pills according to claim 1, wherein said outlet is releasably connected to said receptacle.

16. A receptacle for containing and dispensing solid medicinal pills according to claim 15, wherein said releasable outlet is disposable and replaceable.

17. A receptacle for containing and dispensing solid medicinal pills according to claim 1, wherein said outlet is provided with a stop surface positioned in spaced apart relationship, relative to and outwardly in front of said displaceable sealing closure, said stop surface being provided with air holes enabling air displacement between the mouth of the user and said sealing closure, to open the same, said surface being adapted to deflect a pill exiting said sealing closure and encountering said surface, said outlet being further provided with an opening, positioned to dispense, under the effect of gravity, a pill exiting said sealing closure.

18. A receptacle for containing and dispensing solid medicinal pills according to claim 1, wherein displacement of said closure from said closed position, to enable the dispensing of at least one pill from said chamber, is actuated by an air pressure differential.

19. A receptacle for containing and dispensing solid medicinal pills according to claim 1, wherein said sealing closure is maintained in its closed position by interengagement with a frame provided inside said outlet.

20. A receptacle for containing and dispensing solid medicinal pills, comprising a container with a storage chamber leading to an outlet sized to be comfortably inserted between the lips of the user, said outlet being further provided with a displaceable sealing closure having a normally closed position, and wherein actuation by the mouth of the user interacting with said outlet causes displacement of said displaceable sealing closure from said closed position, to enable the dispensing of at least one pill having a major dimension, the cross-section of which is at least 0.3 cm, from said chamber.
